(19) United States
(12) Patent Application Publication
(10) Pub. No.: US 2022/0084313 A1
(43) Pub. Date: Mar. 17, 2022

(54) VIDEO PROCESSING METHODS AND APPARATUSES, ELECTRONIC DEVICES, STORAGE MEDIUMS AND COMPUTER PROGRAMS

(71) Applicant: Beijing Sensetime Technology Development Co., Ltd., Beijing (CN)

(72) Inventors: Yanmin LI, Beijing (CN); Dongqing LIU, Beijing (CN); Qiuliang HUO, Beijing (CN); Jiwei ZHU, Beijing (CN); Heli LV, Beijing (CN)

(21) Appl. No.: 17/538,537

(22) Filed: Nov. 30, 2021

Related U.S. Application Data
(63) Continuation of application No. PCT/CN2020/130180, filed on Nov. 19, 2020.

(30) Foreign Application Priority Data
Jun. 11, 2020 (CN) 202010531986.0

(51) Int. Cl. G06V 20/40; G06V 10/82; G11B 27/031; G11B 27/06

(52) U.S. Cl. CPC G06V 20/46; G06V 20/49; G11B 27/06; G06V 10/82; G11B 27/031; G06V 20/48

(57) ABSTRACT

Method, systems, apparatus, devices, storage media and computer programs for video processing are provided. In one aspect, a method includes obtaining a reference video that includes at least one type of processing parameters, obtaining a to-be-processed video, cutting the to-be-processed video to obtain a plurality of frame sequences of the to-be-processed video, and editing the plurality of frame sequences according to the at least one type of processing parameters of the reference video to obtain a target video.

### CROSS-REFERENCE TO RELATED APPLICATION

This application is a continuation of PCT International application No. PCT/CN2020/130180 filed on Nov. 19, 2020, which is based on and claims priority to Chinese Patent Application No. 202010531986.0 filed on Jun. 11, 2020, the entire contents of which are incorporated herein by reference.

### TECHNICAL FIELD

The present disclosure relates to the field of image processing and in particular to video processing methods and apparatuses, electronic devices, storage mediums and computer programs.

### BACKGROUND

Along with rapid development of internet and 5G network, there are more and more applications for displaying video contents and efficient extraction of useful information from a large number of videos becomes an important development in the video field. In order to highlight and display useful information in the videos, editing may be performed for video materials.

During an editing process of video materials, manual edit usually requires high professional level of editors and consumes much time and labor, resulting in low efficiency. In this case, it is urgent to realize efficient and professional video edit at present.

### SUMMARY

The present disclosure provides a video processing solution.

According to a first aspect of the present disclosure, there is provided a video processing method, including: obtaining a reference video, where the reference video includes at least one type of processing parameters; obtaining a to-be-processed video; obtaining a plurality of frame sequences of the to-be-processed video by cutting the to-be-processed video; and obtaining a target video by editing the plurality of frame sequences according to the at least one type of processing parameters of the reference video.

In one possible implementation, the target video is matched in mode with the reference video.

In one possible implementation, the target video being matched in mode with the reference video includes at least one of: background music of the target video being matched with background music of the reference video, or an attribute of the target video being matched with an attribute of the reference video.

In one possible implementation, the attribute of the target video being matched with the attribute of the reference video includes at least one of: a number of transitions included in the target video and a number of transitions included in the reference video belonging to a same category, occurrence time of a transition comprised in the target video and occurrence time of a transition included in the reference video belonging to a same time range; a number of scenes included in the target video and a number of scenes included in the reference video belonging to a same category, contents of a scene included in the target video and contents of a scene included in the reference video belonging to a same category, a number of characters included in a segment in the target video and a number of characters included in a corresponding segment of the reference video belonging to a same category, or an editing style of the target video and an editing style of the reference video belonging to a same type.

In one possible implementation, obtaining the target video by editing the plurality of frame sequences according to the at least one type of processing parameters of the reference video includes: generating a respective first intermediate video by performing each of a plurality of combinations for at least part of the plurality of frame sequences according to the at least one type of processing parameters of the reference video; and determining at least one of the respective first intermediate videos of the plurality of combinations as the target video.

In one possible implementation, determining the at least one of the respective first intermediate videos of the plurality of combinations as the target video includes: obtaining a corresponding quality parameter of each of the respective first intermediate videos; and selecting a first intermediate video from the respective first intermediate videos according to the corresponding quality parameters as the target video, where a value of a corresponding quality parameter of the selected first intermediate video is greater than a value of a corresponding quality parameter of an unselected first intermediate video among the respective first intermediate videos.

In one possible implementation, before obtaining the target video by editing the plurality of frame sequences according to the at least one type of processing parameters of the reference video, the method further includes: obtaining a target time range matching a time length of the target video, where generating a respective first intermediate video by performing each of a plurality of combinations for at least part of the plurality of frame sequences according to the at least one type of processing parameters of the reference video includes: generating the respective first intermediate video by performing each of the plurality of combinations for the at least part of the plurality of frame sequences according to the at least one type of processing parameters and the target time range, where the time length of the respective first intermediate video is within the target time range.

In one possible implementation, the processing parameters include a first type processing parameter and a second type processing parameter. Obtaining the target video by editing the plurality of frame sequences according to the at least one type of processing parameters of the reference video includes: obtaining at least one second intermediate video by performing a combination for at least part of the plurality of frame sequences according to the first type processing parameter; obtaining the target video by performing adjustment to the at least one second intermediate video according to the second type processing parameter.

In one possible implementation, the processing parameters includes at least one of: a parameter for reflecting basic data of the reference video as the first type processing parameter, or at least one of a parameter for indicating adding additional data to a second intermediate video or a parameter for indicating cutting the second intermediate video as the second type processing parameter.

In one possible implementation, performing adjustment to the at least one second intermediate video according to the second processing parameter includes at least one of: in a case that the second processing parameter includes a parameter for indicating adding additional data to the second intermediate video, synthesizing the additional data and the second intermediate video; or in a case that the second processing parameter includes a parameter for indicating cutting the second intermediate video, adjusting a length of the second intermediate video according to the second processing parameter.

In one possible implementation, the processing parameters include at least one of: a transition parameter, a scene parameter, a character parameter, an editing style parameter or an audio parameter.

In one possible implementation, before obtaining the target video by editing the plurality of frame sequences according to at least one type of processing parameters of the reference video, the method further includes: detecting and learning the at least one type of processing parameters of the reference video by analyzing the reference video through a pre-trained neural network.

According to an aspect of the present disclosure, there is provided a video processing apparatus, including: a reference video obtaining module, configured to obtain a reference video, where the reference video includes at least one type of processing parameters; a to-be-processed video obtaining module, configured to obtain a to-be-processed video; a cutting module, configured to obtain a plurality of frame sequences of the to-be-processed video by cutting the to-be-processed video; an editing module, configured to obtain a target video by editing the plurality of frame sequences according to at least one type of processing parameters of the reference video.

According to an aspect of the present disclosure, there is provided an electronic device, including: at least one processor; and one or more memories coupled to the at least one processor and storing programming instructions for execution by the at least one processor to perform operations comprising: obtaining a reference video, where the reference video comprises at least one type of processing parameters; obtaining a to-be-processed video; cutting the to-be-processed video to obtain a plurality of frame sequences of the to-be-processed video; and editing the plurality of frame sequences according to the at least one type of processing parameters of the reference video.

According to an aspect of the present disclosure, there is provided a computer readable storage medium coupled to at least one processor having machine-executable instructions stored thereon that, when executed by the at least one processor, cause the at least one processor to perform operations including: obtaining a reference video, wherein the reference video comprises at least one type of processing parameters; obtaining a to-be-processed video; cutting the to-be-processed video to obtain a plurality of frame sequences of the to-be-processed video; and editing the plurality of frame sequences according to the at least one type of processing parameters of the reference video to obtain a target video.

According to an aspect of the present disclosure, there is provided a computer program, where the computer program is executed by the processor to perform the above video processing method.

In an example of the present disclosure, the reference video and the to-be-processed video are obtained first, and then a plurality of frame sequences are obtained by cutting the to-be-processed video, and finally the target video is obtained by editing the plurality of frame sequences according to at least one type of processing parameters of the reference video. In this above process, the processing parameters of the reference video can be learned automatically and similar editing is performed automatically for the to-be-processed video according to the learned processing parameters so as to obtain the target video edited in a similar manner of the reference video, thereby improving the editing efficiency and the editing effect. Those users without basic edit basic skills can also obtain a more convenient video processing solution by use of the above manner, that is, converting a to-be-processed video required to be edited (including but not limited to edit) by a user into a video similar to the reference video.

It is understood that the above general descriptions and subsequent detailed descriptions are merely illustrative and explanatory rather than limiting of the present disclosure.

Other features and aspects of the present disclosure will be become clear after the illustrative examples are detailed with reference to accompanying drawings.

### BRIEF DESCRIPTION OF THE DRAWINGS

The accompanying drawings, which are incorporated in and constitute a part of the present specification, illustrate examples consistent with the present disclosure and serve to explain the technical solutions of the present disclosure together with the specification.

FIG. 1 is a flowchart of a video processing method according to an example of the present disclosure.

FIG. 2 is a schematic diagram illustrating an application example of the present disclosure.

FIG. 3 is a block diagram of a video processing apparatus according to an example of the present disclosure.

FIG. 4 is a block diagram of an electronic device according to an example of the present disclosure.

FIG. 5 is a block diagram of an electronic device according to an example of the present disclosure.

### DETAILED DESCRIPTION OF THE EMBODIMENTS

The various illustrative examples, features and aspects of the present disclosure will be detailed in combination with the accompanying drawings. Like numerals in the accompanying drawings represent elements with like or similar function. Although various aspects of the examples of the present disclosure are shown in the accompanying drawings, the drawings are not necessarily drawn to scale unless otherwise indicated.

The term “illustrative” herein means “used as example, embodiment or descriptive”. Any example described as illustrative herein is not necessarily interpreted as superior to or better than other examples.

The term “and/or” herein is used only to represent three association relationships for description of associated objects, for example, A and/or B may refer to that A exists alone, or both A and B exist, or B exists alone. Further, the term “at least one” herein represents any one of multiple or any combination of at least two of multiple, for example, refers to at least one of A, B and C, or any one or more elements selected from a set of A, B and C.

In addition, in order to better describe the present disclosure, many specific details are given in the following specific implementations. Those skilled in the art should understand that the present disclosure can be still practiced without some specific details. In some examples, those methods, approaches, elements and circuits well known to those skilled in the art are not detailed to highlight the gist of the present disclosure.

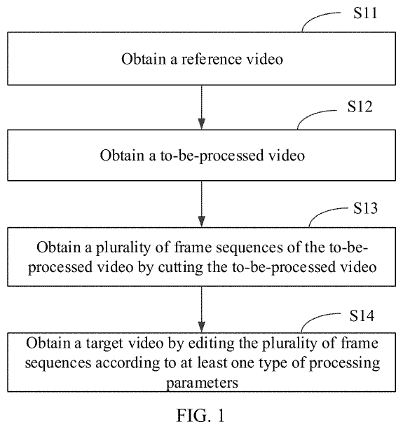

FIG. 1 is a flowchart of a video processing method according to an example of the present disclosure. The method may be applied to a video processing device. In one possible implementation, the video processing device may be a terminal device, or another processing device or the like. The terminal device may be user equipment (UE), a mobile device, a user terminal, a terminal, a cellular phone, a cordless phone, a personal digital assistant (PDA), a handheld device, a computing device, a vehicle-mounted device, a wearable device and so on.

In some possible implementations, the video processing method may also be implemented by invoking computer-readable instructions in a memory using a processor.

As shown in FIG. 1, in one possible implementation, the video processing method may include the following blocks.

At block S11, a reference video is obtained, where the reference video has at least one type of processing parameters.

At block S12, a to-be-processed video is obtained.

At block S13, a plurality of frame sequences of the to-be-processed video are obtained by cutting the to-be-processed video.

At block S14, a target video is obtained by editing the plurality of frame sequences according to at least one type of processing parameters of the reference video.

The specific type of the processing according to the video processing method provided in the example may be determined flexibly according to actual situations. For example, the processing type may be editing, cropping, optimization or splicing or the like for a video, which are collectively called “editing”. The specific “editing” involved in each example of the present disclosure subsequently is only provided as an example for describing the video processing method of the present disclosure. The term “editing” shall be interpreted in the broadest sense to cover any video processing relating to the “editing”. In addition, other video processing manners not mentioned in the present disclosure may also be flexibly used based on the existing examples of the present disclosure.

The to-be-processed video may be any video having processing requirement. For example, the to-be-processed video may be a video having editing requirement. The manner of obtaining the to-be-processed video is not limited in the examples of the present disclosure. For example, the to-be-processed video may be a video taken by, for example, a terminal having an image collection function or obtained from a local server or a remote server or the like. The number of the to-be-processed videos may be one or more, which is also not limited in the examples of the present disclosure. When there are several to-be-processed videos, the several to-be-processed videos may be processed simultaneously according to processing parameters of a reference video; or each of the several to-be-processed videos is processed according to the processing parameters of the reference video; or one part of the several to-be-processed videos are processed according to one part of the processing parameters of the reference video and the other part of the several to-be-processed videos are processed according to the other part of the processing parameters of the reference video. The specific video processing manner may be flexibly determined according to actual processing requirements, which is not limited in the examples of the present disclosure.

After the to-be-processed video is obtained, a plurality of frame sequences of the to-be-processed video may be obtained by cutting the to-be-processed video as per block S13, where each frame sequence includes at least one image frame. In the examples of the present disclosure, the specific manner of cutting the to-be-processed video may be selected flexibly according to actual situations, which is not limited to the following examples of the present disclosure.

In one possible implementation, the to-be-processed video may be cut into a plurality of frame sequences, each of which has a same or a different time length. The basis of performing cutting may be flexibly selected according to actual situations. In one possible implementation, the to-be-processed video may be cut according to at least one cutting parameter to obtain at least one frame sequence of the to-be-processed video. The cutting parameter may identical to or different from the processing parameter of the reference video. In one possible implementation, the cutting parameter may include one or more of style, scene, character (or person), action, size, background, anomaly, jitter, color shade, direction, frame quality and so on of the to-be-processed video. When the cutting parameter includes more than one of the above listed, the to-be-processed video may be cut according to each cutting parameter to obtain at least one frame sequence under each cutting parameter; or the to-be-processed video may be cut according to all the cutting parameters to obtain at least one frame sequence with all the cutting parameters in consideration.

In one possible implementation, the process of cutting the to-be-processed video may be realized by a neural network. In an example, the to-be-processed video may be cut by a first neural network to obtain at least one frame sequence of the to-be-processed video, where the first neural network may be a neural network having a video cutting function. The specific implementation manner may be flexibly determined according to actual situations. In one possible implementation, one initial first neural network may be established, and then trained by first training data to obtain the first neural network. In one possible implementation, the first training data for training the initial first neural network may be any video or a plurality of frame sequences obtained by cutting the video, and the like. In one possible implementation, the first training data for training the initial first neural network may be any video containing cutting label used to indicate at which time points the video will be cut and so on.

The reference video usually refers to a video having a video mode desired by a user. Specifically, the reference video may be any video or one or more designated videos for reference. The contents and number of the reference videos may be selected flexibly according to actual situations, which are not limited in the examples of the present disclosure. In one possible implementation, because the to-be-processed video may be processed according to at least one processing parameter of the reference video, the reference video may be a processed video, for example, an edited video. In one possible implementation, the reference video may be an unprocessed video, for example, some videos which have good video style and rhythm in spite of not being processed. Specifically, which video will be selected as the reference video will be determined according to actual requirements.

The number of the reference videos may be one or more, which is not limited in the examples of the present disclosure. When several reference videos are used, the to-be-processed video may be processed by referring to the processing parameters of the several reference videos at one time, or processed according to the processing parameters of each reference video in sequence, or processed based on the processing parameters of at least part of reference videos selected from the several reference videos randomly or as per a specific rule. The specific manner of the implementation may be flexibly determined according to actual situations, which is not limited in the examples of the present disclosure. The subsequent examples of the present disclosure will be described with one reference video as example. In a case of using several reference videos, flexible extension may be performed by referring to subsequent examples, which will not be described again.

The processing parameters of the reference video may be determined according to actual processing requirements, and the form and number of the processing parameters may be flexibly determined according to actual situations and will not be limited to the following examples of the present disclosure. In one possible implementation, the processing parameters may be parameters relating to editing. In one possible implementation, the processing parameters may include at least one of: transition parameter, scene parameter, character parameter, editing style parameter, and audio parameter and the like. For example, the processing parameters may include the transition parameter (for example, transition time point, transition effect and transition number and so on) of the editing, video edit style parameter (fast rhythm or slow rhythm or the like), scene parameter (background or scenery or the like), character parameter (a time of appearance of a character (or person), a number of appearing characters and the like), content parameter (plot development, drama type and the like) and parameters indicating background music or subtitle and the like. How to process the to-be-processed video according to which parameter or parameters of the reference video will be determined flexibly, which will be detailed in the following examples.

It is noted that the implementation sequence of blocks S11 and S12 is not limited in the examples of the present disclosure. Specifically, the sequence of obtaining the reference video and the to-be-processed video is not limited, that is, the reference video and the to-be-processed video may be obtained simultaneously, or the reference video may be obtained before the to-be-processed video is obtained, or the to-be-processed video may be obtained before the reference video is obtained, or the like. The sequence of obtaining the reference video and the to-be-processed video may be selected according to actual situations. In one possible implementation, it is guaranteed that block S11 is performed before block S14.

After the reference video and a plurality of frame sequences of the to-be-processed video are obtained, the plurality of frame sequences may be edited based on at least one type of processing parameters of the reference video through block S14. The manner of editing may be selected flexibly according to actual situations, which is not limited to the examples of the present disclosure.

In one possible implementation, after a plurality of frame sequences are obtained by cutting the to-be-processed video, the plurality of obtained frame sequences may be spliced according to at least one type of processing parameters of the reference video. During a splicing process, the plurality of obtained frame sequences or part selected therefrom may be spliced together, which may be selected flexibly according to actual requirements. The manner of performing splicing according to the processing parameter may be flexibly determined according to the type of processing parameters and will not be limited in the examples of the present disclosure. For example, according to a scene corresponding to the scene parameter included in the processing parameters, frame sequences similar to the scene are selected from the plurality of frame sequences obtained by cutting, and spliced according to the transition parameter included in the processing parameters and so on. Because the processing parameters have various forms and various combinations, other splicing manners according to the processing parameters will not be enumerated herein.

In one possible implementation, the process of editing a plurality of frame sequences according to at least one type of processing parameters may also be realized through a neural network. In an example, splicing frame sequences based on processing parameters may be performed by a second neural network. It is noted that the “first” and “second” in the first neural network and the second neural network are used only to indicate difference in function or purpose of the neural networks and their specific implementation and training manners may be same or different, which are not limited in the examples of the present disclosure. The neural networks with other numerals appearing afterwards are similar to the neural networks herein and will not be described one by one.

The second neural network may be a neural network having the function of splicing and/or editing frame sequences according to processing parameters or a neural network having the function of extracting processing parameters from the reference video and splicing and/or editing the frame sequences according to the processing parameters, the specific implementation of which may be determined flexibly according to actual situations. In one possible implementation, an initial second neural network may be established and then trained by second training data to obtain the second neural network. The “first” and “second” in the first training data and the second training data are used only to distinguish training data under different neural networks, the specific implementation of which may be same or different and will not be limited herein. The training data with other numerals appearing afterwards will be similar to the training data herein and thus will not be described one by one. In one possible implementation, the second training data for training the initial second neural network may include a plurality of frame sequences, at least one processing parameter as above, and a splicing result of the frame sequences obtained based on the processing parameter. In one possible implementation, the second training data for training the initial second neural network may include a plurality of frame sequences, a reference video, and a splicing result of the frame sequences obtained based on the processing parameters of the reference video.

A plurality of frame sequences are obtained by cutting the to-be-processed video, and then edited according to at least one type of processing parameters of the reference video. In the above process, frame sequences which are relatively complete and fit with the contents of the to-be-processed video may be obtained by cutting the to-be-processed video according to the actual situations of the to-be-processed video, and then spliced according to the processing parameters of the reference video. In such way, the spliced video is similar to the processing style of the reference video and has contents that are relatively complete and close to the to-be-processed video, thereby improving the authenticity and completeness of a processing result finally obtained and effectively increasing the video processing quality.

In one possible implementation, the entire process of the above blocks S13 and S14 may also be accomplished by a neural network. In an example, the processing parameters of the reference video may be obtained through a third neural network and then a processing result is obtained by performing combination for at least part of a plurality of frame sequences obtained by cutting the to-be-processed video according to the obtained processing parameters. The specific implementation of the third neural network may be flexibly selected according to actual situations, which will not be limited herein. In one possible implementation, one initial third neural network may be established and then trained by third training data to obtain the third neural network. In one possible implementation, the third training data for training the initial third neural network may include the reference video and the to-be-processed video as above, and may further include a processing result video obtained by editing the to-be-processed video according to the parameters of the reference video. In one possible implementation, the third training data for training the initial third neural network may include the reference video and the to-be-processed video as above where the to-be-processed video contains edit label for indicating at which time points the to-be-processed video will be edited and so on.

With different types of processing parameters, block S14 may also be implemented in many other manners, which will be detailed in the following examples.

In an example of the present disclosure, the reference video and the to-be-processed video are obtained first, and then a plurality of frame sequences are obtained by cutting the to-be-processed video, and finally the target video is obtained by editing at least part of the plurality of frame sequences according to at least one type of processing parameters of the reference video. In this above process, the processing parameters of the reference video can be learned automatically and similar editing is performed automatically for the to-be-processed video according to the learned processing parameters so as to obtain the target video edited in a similar manner of the reference video, thereby improving the editing efficiency and the editing effect. Those users without basic edit skills can also obtain a more convenient video processing solution by use of the above manner, that is, converting a to-be-processed video required to be edited (including but not limited to edit) by a user into a video similar to the reference video.

It can be seen from the above various examples that the target video may be obtained by blocks S11-S14. The form of the obtained target video may be flexibly determined according to the specific implementation process of blocks S11-S14 and will not be limited in the examples of the present disclosure. In one possible implementation, the target video may be matched in mode with the reference video.

Mode match refers to that the target video and the reference video have the same or similar mode. The specific meaning of the mode may be flexibly determined according to actual situations and will not be limited to the following examples. For example, the target video and the reference video may be divided into video segments in the same manner, and corresponding video segments (i.e. one video segment in the target video and one video segment in the reference video) have same or similar time length, contents, style and so on. In this case, it is determined that the target video is matched in mode with the reference video.

Because the target video is matched in mode with the reference video, the target video may be obtained based on an editing manner similar to that of the reference video so as to help learn the style of the reference video and quickly and efficiently obtain the target video with good editing effect.

In one possible implementation, the target video being matched in mode with the reference video includes at least one of the following: background music of the target video is matched with background music of the reference video; and an attribute of the target video is matched with an attribute of the reference video.

The background music of the target video being matched with the background music of the reference video may be that the target video and the reference video adopt the same background music or the same type of background music, where the same type of background music refers to background music with the same and/or similar music style. For example, the background music of the reference video is blues rock and the background music of the target video may also be blues rock, or punk or heavy metal or non-rock jazz similar to the blues rock in rhythm.

As mentioned in the preceding examples, the reference video may include at least one type of processing parameters. Accordingly, the reference video may have one or more attributes. Therefore, the target video being matched with the reference video in attribute may refer to being matched in a particular attribute or being matched in a plurality of attributes or the like. The specific attributes involved in the matching will be selected flexibly according to actual situations.

The target video being matched with the reference video in mode may be realized by the target video being matched with the reference video in background music and/or attribute. A mode matching degree of the target video and the reference video may be selected flexibly according to actual situations so as to enable more flexible edit of the target video, thereby greatly improving the flexibility and application scope of the video processing.

In one possible implementation, the target video being matched with the reference video in attribute may include at least one of the following: a number of transitions included in target video and a number of transitions included in reference video belong to a same category, and/or occurrence time of a transition included in target video and occurrence time of a transition included in reference video belong to a same time range; a number of scenes included in target video and a number of scenes included in reference video belong to a same category, and/or, contents of a scene included in target video and contents of a scene included in reference video belong to a same category; a number of characters included in a segment of target video and a number of characters included in a corresponding segment of reference video belong to same category; or an editing style of target video and an editing style of reference video belong to a same type.

The number of transitions included in the target video and the number of transitions included in the reference video belong to a same category, which means that the number of transitions included in the target video and the number of transitions included in the reference video are identical, or that the number of transitions included in the target video and the number of transitions included in the reference video are close to each other, or that the number of transitions included in the target video and the number of transitions included in the reference video are within a same interval. The interval of the number of transitions included in the target video and the reference video may be flexibly determined according to actual situations, for example, every five transitions are determined as an interval and so on. In an example, the number of transitions included in the target video and the number of transitions included in the reference video belong to a same category, which further means that a ratio of the number of transitions of the target video to the time length of the target video is equal to or close to a ratio of the number of transitions of the reference video to the time length of the reference video and the like.

The occurrence time of a transition of the target video and the occurrence time of a transition of the reference video belong to a same time range, which means that transition occurs to the target video and the reference video at a same time point or at close time points, or that a ratio of a transition time point of the target video to the time length of the target video is identical to or close to a ratio of a transition time point of the reference video to the time length of the reference video. Since the target video and the reference video may include several transitions, a time of each transition of the target video and a time of each transition of the reference video both belong to a same time range in one possible implementation, and occurrence time of one or more transitions of the target video and occurrence time of one or more transitions of the reference video may also belong to a same time range in one possible implementation.

The number of scenes included in the target video and the number of scenes included in the reference video belong to a same category, which means that the number of scenes of the target video and the number of scenes included in the reference video are identical or close to each other, or that a ratio of the number of scenes of the target video to the time length of the target video is identical to or close to a ratio of the number of scenes of the reference video to the time length of the reference video or the like.

The contents of scenes included in the target video and the reference video belong to a same category, which means that the target video and the reference video include same or similar scenes, or that the types of scenes of the target video and the reference video are same or similar or the like. The categorization of the contents of scenes may be determined flexibly according to actual situations and will not be limited in the examples of the present disclosure. In one possible implementation, the contents of scenes may be roughly categorized, for example, the scenes such as forest, sky and ocean may be considered as belonging to the same nature category. In one possible implementation, the contents of scenes may also be categorized more finely, for example, forest and grassland are considered as belonging to a same land scenery category, while river and cloud are considered as belonging to an aquatic scenery category and a sky scenery category and so on.

The numbers of characters included in corresponding segments of the target video and the reference video belong to same category, where the corresponding segments and the category of numbers of characters may also be determined flexibly according to actual situations. In one possible implementation, corresponding segments may be segments of corresponding scenes or transitions in the target video and the reference video and the like. In one possible implementation, corresponding segments may also be frame sequences at a corresponding time in the target video and the reference video and the like. The numbers of characters belong to a same category, which means that the numbers of characters included in corresponding segments of the reference video and the target video are identical or close to each other. For example, the number of characters may be divided into a plurality of intervals. When the numbers of characters in the target video and the reference video belong to a same interval, it is considered that the numbers of characters included in corresponding segments of the target video and the reference video belong to a same category. The specific manner of the interval division of the number of characters may be set flexibly according to actual situations, which will not be limited in the examples of the present disclosure. In one possible implementation, every two to five persons and the like may be assigned to a same interval, for example, every five persons are determined as one interval. In this case, when the number of characters in the target video is three and the number of characters in the reference video is five, it is determined that the numbers of characters in the target video and the reference video belong to a same interval.

The editing styles of the target video and the reference video belong to a same type, which means that the target video and the reference video have same or similar editing style, where the specific manner of the type division of the editing styles may be determined flexibly according to actual situations. For example, the types of the editing styles may include speed of rhythm of edited video, whether the editing is directed to character or scenery, or emotion type of edited video and the like.

By the matching of the attribute including transition number, transition time, scene number, scene content, character number, and editing style and the like, the flexibility and matching degree of the target video and the reference video can be further improved, and the flexibility and application scope of the video edit can also be further improved.

As mentioned in the preceding examples, the implementation manner of the block S14 may be determined according to actual situations. Therefore, in one possible implementation, block S14 may include: at block S141, obtaining a plurality of first intermediate videos by performing several combinations for at least part of a plurality of frame sequences according to at least one type of processing parameters of the reference video, where one first intermediate video is obtained from each combination; and at block S142, determining at least one of the plurality of first intermediate videos as the target video.

In one possible implementation, in the process of obtaining the target video at block S14, a plurality of first intermediate videos may be firstly obtained by performing several combinations for at least part of a plurality of frame sequences according to at least one type of processing parameters of the reference video, and then the final target video is obtained from these intermediate videos.

The process of performing several combinations for at least part of a plurality of frame sequences according to at least one type of processing parameters of the reference video at block S141 may be accomplished flexibly according to actual situations, without being limited to the following examples.

Specifically, in a plurality of frame sequences obtained by cutting, which frame sequences or which image frames in the frame sequences are to be combined will be determined flexibly according to the processing parameters of a reference video. In one possible implementation, similar frame sequences or part of image frames in the similar frame sequences are selected from a plurality of frame sequences obtained by cutting according to a transition time point, transition number, editing style, character and content and the like of the reference video, and then combination is performed for the selected frame sequences or selected image frames according to the transition effect of the reference video, and the like. When the to-be-processed video is edited according to at least one type of processing parameters of the reference video, all frame sequences of the to-be-processed video may be retained according to actual requirements or part of frame sequences or part of image frames in the part of frame sequences may be deleted and the like. The specific processing manner for this will be selected according to the processing parameters of the reference video and will not be limited in the examples of the present disclosure.

During the process of performing combination for at least part of a plurality of frame sequences according to at least one type of processing parameters of the reference video, several combinations may be performed, where different combinations may be performed by using same or different frame sequences or further using same or different image frames in a case of using the same frame sequences, which may be flexibly determined according to actual situations. Therefore, in one possible implementation, several combinations may be achieved in the following manner: at least two combinations of the several combinations use different frame sequences; or, each combination of the several combinations uses same frame sequences.

It can be seen that different first intermediate videos may be obtained using different frame sequences in one possible implementation; different first intermediate videos may be obtained by performing different combinations for the same frame sequences in one possible implementation; different first intermediate videos may be obtained by performing same or different combinations for different image frames in the same frame sequences in one possible implementation; different first intermediate videos may be obtained by performing different combinations for the same image frames in the same frame sequences in one possible implementation. It should be understood that the manner of performing combination for at least part of a plurality of frame sequences may be not limited to the several examples as listed above. In the above process, the number and composition of the first intermediate videos may be significantly enriched, thereby facilitating selecting a more proper target video, and improving the flexibility and processing quality of the video processing procedure.

The “combination” operation performed for frame sequences/image frames in the described examples of the present disclosure may include: splicing frame sequences/image frames together in an order of time or space. In one possible implementation, the “combination” operation may further include: performing feature extraction for frame sequences/image frames and synthesizing frame sequences/image frames according to the extracted features. The specific combination of frame sequences/image frames may be determined according to at least one type of processing parameters of the reference video learned from the reference video through a neural network. The “combination” operation is described herein by only several possible examples but not limited to the several possible examples.

As described in the above examples, the process of performing combination for at least part of a plurality of frame sequences according to the processing parameters of the reference video may be realized through a neural network. Therefore, in one possible implementation, block S141 may also be realized through the neural network. The manner of implementation may be referred to the above examples and will not be repeated herein. It is noted that in the examples of the present disclosure, the neural network for realizing block S141 may output several results, that is, the neural network for realizing block S141 may output several videos based on the input several frame sequences, and then use the several output videos as first intermediate videos to further perform selection through block S142 and finally obtain the target video.

In one possible implementation, the first intermediate video may also have some additional restriction conditions to restrict the process of performing combination for at least part of a plurality of frame sequences, where the specific restriction condition may be determined flexibly according to actual requirements. In one possible implementation, the restriction condition includes: a time length of the first intermediate video belongs to a target time range matched with a time length of the target video. Therefore, in one possible implementation, before block S14, the following may be further included: obtaining a target time range where the target time range is matched with the time length of the target video. In this case, block S141 may further include: obtaining a plurality of first intermediate videos by performing several combinations for at least part of a plurality of frame sequences according to at least one type of processing parameters of the reference video and the target time range, where one first intermediate video is obtained from each combination and the time length of each first intermediate video belongs to the target time range.

The target time range may be a time range determined flexibly according to the time length of the target video, which may be identical to the time length of the target video or within a particular approximate interval of the time length of the target video. The specific length of the interval and its offset relative to the time length of the target video may be set flexibly according to actual requirements and will not be limited in the examples of the present disclosure. In one possible implementation, the target time range may be set to be equal to or less than half of the time length of the to-be-processed video or the like.

It can be seen from the above examples that in one possible implementation, the time length of the first intermediate video may be set to be within the target time range, so that a plurality of first intermediate videos having the time length within the target time range may be obtained through combination by setting the target time range during the process of performing combination for the frame sequences of the to-be-processed video according to the processing parameters of the reference video.

By setting the target time range, each first intermediate video obtained through combination will have the time length within the target time range, so that some combination results non-compliant with the time length requirements will be effectively eliminated directly, thereby reducing the difficulty of subsequently selecting the target video based on the first intermediate videos and improving the efficiency and convenience of the video processing.

The implementation of the block S142 is not limited herein, that is, the manner of determining the target video from a plurality of first intermediate videos is not limited. For example, the number of first intermediate videos determined as the target video is not limited and may be flexibly set according to actual requirements. In one possible implementation, at least one of the plurality of first intermediate videos may be determined as the target video.

A plurality of first intermediate videos are obtained by performing several combinations for at least part of a plurality of frame sequences according to at least one type of processing parameters of the reference video and then at least one of the plurality of first intermediate videos is determined as the target video. In the above process, a good target video may be selected by performing several possible combinations for a plurality of frame sequences of the to-be-processed video according to the processing parameters of the reference video. In this way, the flexibility of the video processing is improved and the quality of the video processing is increased.

In one possible implementation, block S142 may include: at block S1421, obtaining a quality parameter of each of a plurality of first intermediate videos; at block S1422, determining the target video from the plurality of first intermediate videos according to the quality parameters, where the value of the quality parameter of the first intermediate video determined as the target video is greater than the value of quality parameter of the first intermediate video not determined as the target video.

In one possible implementation, a plurality of first intermediate videos with the highest quality are determined as a processing result, where the quality of the first intermediate videos may be determined according to the quality parameters. The implementation form of the quality parameters is not limited and may be set flexibly according to actual situations. In one possible implementation, the quality parameter may include one or more of photographing time, length, location, scene and content of the first intermediate video, and the selection or combination of these items included in the quality parameter may be flexibly determined according to actual situations. For example, the quality parameter of the first intermediate video may be determined according to whether the photographing time of the first intermediate video is continuous, whether the length of the first intermediate video is proper, whether a location appearing in the first intermediate video is similar to that in the reference video, whether scene switching in the first intermediate video is stiff, whether characters in the contents of the first intermediate video are complete, or whether the story is smooth or the like. In one possible implementation, the quality parameter of the first intermediate video may also be determined according to a fitness degree of the first intermediate video and the reference video.

The implementation manner of the block S1421 is not limited in the examples of the present disclosure, that is, the manners of obtaining the quality parameters of different first intermediate videos may be flexibly determined according to actual situations. In one possible implementation, the process of the block S1421 may be realized through a neural network. In an example, the quality parameter of the first intermediate video may be obtained through a fourth neural network, where the implementation manner of the fourth neural network is not limited and may be selected flexibly according to actual situations. In one possible implementation, an initial fourth neural network may be established and then trained by fourth training data to obtain the fourth neural network. In one possible implementation, the fourth training data for training the initial fourth neural network may include the reference video and a plurality of first intermediate videos as described above, where the first intermediate videos may be labeled with quality scores given by professionals so that more accurate quality parameters may be obtained through the trained fourth neural network.

After the quality parameters of different first intermediate videos are obtained, the target video may be selected in step S1422 from the first intermediate videos according to the quality parameters, where the value of the quality parameter of the first intermediate video selected as the target video may be greater than the value of the quality parameter of the first intermediate video not determined as the target video. That is, one or more first intermediate videos with the highest quality parameter are selected as the target video. The manner of selecting one or more first intermediate videos with the highest quality parameter as the target video according to the quality parameters of a plurality of first intermediate videos may be flexibly determined according to actual situations. In one possible implementation, a plurality of first intermediate videos may be sorted in a descending order of quality parameter or in an ascending order of quality parameter and then N first intermediate videos may be selected as the target videos from the sorted sequence according to the desired number of target videos, where N is not limited in the examples of the present disclosure and may be flexibly set according to the final desired number of target videos. Accordingly, In a case that the target video is determined from the first intermediate videos by sorting the quality parameters, the fourth neural network may also realize the functions of quality parameter acquisition and quality parameter sorting at the same time, that is, a plurality of first intermediate videos are input into the fourth neural network which outputs the quality parameters and the sorting order of the first intermediate videos by the quality parameter acquisition and sorting.

The quality parameter of each of a plurality of first intermediate videos is obtained and then the target video is selected from the plurality of first intermediate videos according to the quality parameters. In the above process, a target video with good quality may be selected from several combination results of the to-be-processed video, thereby effectively improving the quality of video processing.

As described above, block S14 may be performed in several possible manners and the several possible manners may be flexibly changed according to the different types of the processing parameters. Thus, in one possible implementation, the processing parameters may include the first processing parameter and the second processing parameter. In this case, block S14 may include:

obtaining at least one second intermediate video by performing combination for at least part of the frame sequences according to the first processing parameter; and obtaining the target video by performing adjustment to the at least one second intermediate videos according to the second processing parameter.

The first processing parameter and the second processing parameter may be part of the processing parameters mentioned in the above examples, and the specific form and the type of the first and second processing parameters may be flexibly determined according to actual situations. In one possible implementation, the first processing parameter may include a parameter for reflecting basic data of the reference video; and/or the second processing parameter may include at least one of: a parameter for indicating adding additional data to the second intermediate video, and a parameter for indicating cutting the second intermediate video.

It can be seen from the above examples that the first processing parameter may include some parameters having reference value for the combination manner during the combination of some frame sequences of the to-be-processed video, for example, the transition parameter, the scene parameter and the character parameter and the like mentioned in the above examples. The second processing parameter may include some parameters having a weak relationship with the combination of the frame sequences or synthesized later during the video processing procedure, for example, the audio parameter (background music, human sound and the like), the subtitle parameter, or the time length parameter for adjusting the time length of the second intermediate video or the like as mentioned in the above examples.

The process of performing combination for at least part of the frame sequences according to the first processing parameter is already described in the above examples in which combination is performed for at least part of the frame sequences according to the processing parameters and thus will not be repeated herein. In one possible implementation, the second intermediate video obtained may be a result obtained by performing combination for at least part of the frame sequences; and in one possible implementation, the second intermediate video obtained may also be a result obtained by quality sorting and selection after performing combination for at least part of the frame sequences.

After the second intermediate videos are obtained, adjustment may be performed to the second intermediate videos according to the second processing parameter, where the specific adjustment manner is not limited in the examples of the present disclosure and will not be limited to the following examples. In one possible implementation, adjusting the second intermediate video may include at least one of: in a case that the second processing parameter includes a parameter for indicating adding additional data to the second intermediate video, synthesizing the additional data and the second intermediate video; or in a case that the second processing parameter includes a parameter for indicating cutting the second intermediate video, adjusting the length of the second intermediate video according to the second processing parameter.

As mentioned in the above example, the second processing parameter may include some parameters having a weak relationship with the combination of the frame sequences or synthesized later during the video processing procedure. Therefore, in one possible implementation, the additional data indicated by the second processing parameter may be synthesized with the second intermediate video, for example, the background music is synthesized with the second intermediate video, or the subtitle is synthesized with the second intermediate video, or the subtitle and the background music are both synthesized with the second intermediate video or the like.

In addition, the length of the second intermediate video may also be adjusted according to the second processing parameter. In one possible implementation, a requirement may be set for the time length of the finally-obtained target video, and therefore the length of the second intermediate video may be adjusted flexibly according to the second processing parameter. In one possible implementation, the second intermediate video may be a result selected from the first intermediate videos sorted in the order of quality parameter. As mentioned in the above examples, the time length of the first intermediate video may already belong to the target time range. In this case, only fine adjustment may be performed to the length of the second intermediate video so that the second intermediate video is strictly in compliance with the length required by the processing result and the like.

The additional data indicated by the second processing parameter may be synthesized with the second intermediate video, and/or the length of the second intermediate video may be adjusted according to the second processing parameter. In the above process, according to the second processing parameter, the quality of the processed video may be further improved, thereby further improving the video processing effect.

In one possible implementation, the second intermediate video is obtained by performing combination for at least part of frame sequences/frame images of a plurality of frame sequences of the to-be-processed video according to the first processing parameter, and then the final processing result is obtained by performing further adjustment to the second intermediate video according to the second processing parameter. In this case, during the combination of at least part of a plurality of frame sequences of the to-be-processed video, attention may be paid only to the first processing parameter requiring no further adjustment to improve the combination efficiency, thereby improving the efficiency of the entire video processing procedure.

Further, in the video processing method in the examples of the present disclosure, several neural networks (the first neural network to the fourth neural network and so on) may be flexibly combined or merged according to the actual process of video processing, so that the video processing procedure may be achieved based on any form of neural network, where the specific combination or merging manner is not limited herein. The various combination manners in the examples of the present disclosure are merely illustrative and will not be limited to these examples of the present disclosure during actual application process.

In one possible implementation, the present disclosure further provides an application example. The application example provides a video editing method which may realize automatic editing for a to-be-processed video based on a reference video.

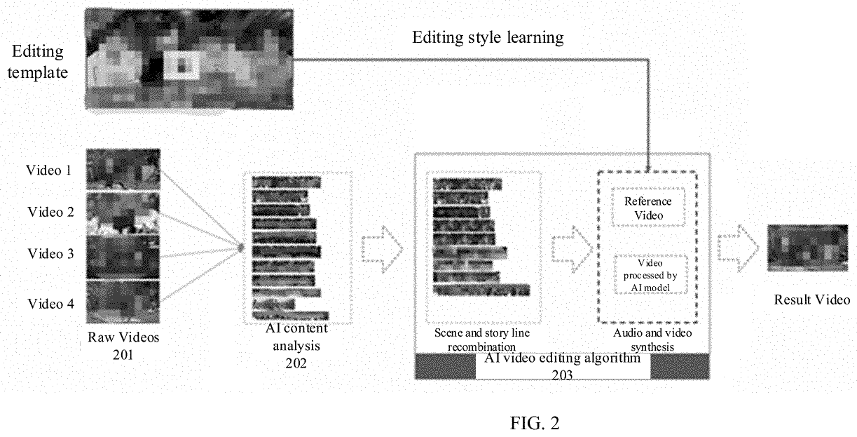

FIG. 2 is a schematic diagram of an application example according to the present disclosure. As shown in FIG. 2, the video editing method provided in the application example is performed in the following process.

First, a plurality of frame sequences are obtained by cutting a to-be-processed video.

As shown in FIG. 2, in the application example of the present disclosure, a plurality of raw videos 201 may be firstly taken as to-be-processed videos and then cut according to a criterion which may be determined flexibly according to actual situations. For example, the raw video may be cut into a plurality of segments according to style, scene, character, action, size, background, anomaly part, jitter part, color shade part, direction, and segment quality and the like of the to-be-processed video.

In the application example of the present disclosure, the to-be-processed video may be cut with a neural network 202 having a video cutting function, that is, a plurality of raw videos are input as to-be-processed videos into the neural network having a video cutting function, and then a plurality of frame sequences output by the neural network are taken as a cutting result. A reference may be made to the first neural network mentioned in the above examples for the implementation form of the neural network having a video cutting function and thus relevant descriptions will not be repeated herein.

Second, a target video is obtained by editing the plurality of frame sequences based on a reference video.

As shown in FIG. 2, in the application example of the present disclosure, the process of editing the plurality of frame sequences obtained through the cutting based on the reference video may be accomplished by a neural network 203 having an editing function. In the application process, the plurality of frame sequences obtained by the cutting and the reference video are input into the neural network having an editing function and a video output by the neural network is taken as a target video.

Further, as shown in FIG. 2, the specific implementation process of the neural network having an editing function may include the following.

Learning the reference video: the neural network having an editing function may detect processing parameters in the reference video, for example, scene, content, character, style, transition effect and music and the like of video and audio, and then these processing parameters are learned and analyzed.

Recombining frame sequences: N first intermediate videos (N>1) are generated from the plurality of obtained frame sequences according to a target time range (for example, two-minute video), and then the N first intermediate videos are scored according to quality parameters of each first intermediate video such as photographing time, length, location, scene, character in the first intermediate video, and event in the first intermediate video so that one or more first intermediate videos with high score are selected by sorting, where the target time range may be flexibly set according to actual situations, for example, may be set to be equal to or less than half of the length of the to-be-processed video.

Synthesizing audio and video: audio and video synthesis is performed for the obtained one or more first intermediate videos with high score according to editing style or music rhythm of the reference video. For example, when a target video with a time length being 60 seconds is to be obtained, music, transition and point location of 60 seconds may be extracted from a reference video equal to or greater than 60 seconds and then music and transition effect synthesis (if a synthesized video has a length greater than that required, for example, 60 seconds, the excess length may be re-adjusted to ensure that the obtained target video is 60 seconds) is performed for a plurality of first intermediate videos of greater than 60 seconds obtained above (for example, first intermediate videos greater than 90 seconds may be selected).

The manner of training the neural network having an editing function may be referred to the above examples and will not be repeated herein.

In one possible implementation, after selecting one or more videos to be edited on an interface of a terminal, a user may depress the “edit” button on the interface to perform the video processing method described in the examples of the present disclosure. Of course, the “edit” operation may also be triggered in another manner, which will not be limited in the examples of the present disclosure. The entire process of editing the selected video may be run automatically on the terminal without any manual operation.

In the application example of the present disclosure, automatic editing may be performed for a video or a live video by the video processing method described in the examples of the present disclosure, thus greatly improving the post-processing efficiency of video in the video industry.

It is noted that in addition to being applied to the above scene of video editing, the method in the above application example may also be applied to other scenes requiring video processing or scenes of image processing and the like, for example, video cropping or image re-splicing and the like and thus will not be limited to the above application example.

It is understood that the above method examples of the present disclosure may be combined with each other to form a combined example without violating principle logics, which will not be redundantly described for limited space.

Those skilled in the art may understand that the drafting sequence of various blocks in the above method of the detailed descriptions of the embodiments does not mean such sequence will be strictly followed to limit the implementation process. Rather, the specific performance sequence of various blocks shall be determined according to function and possible internal logics.

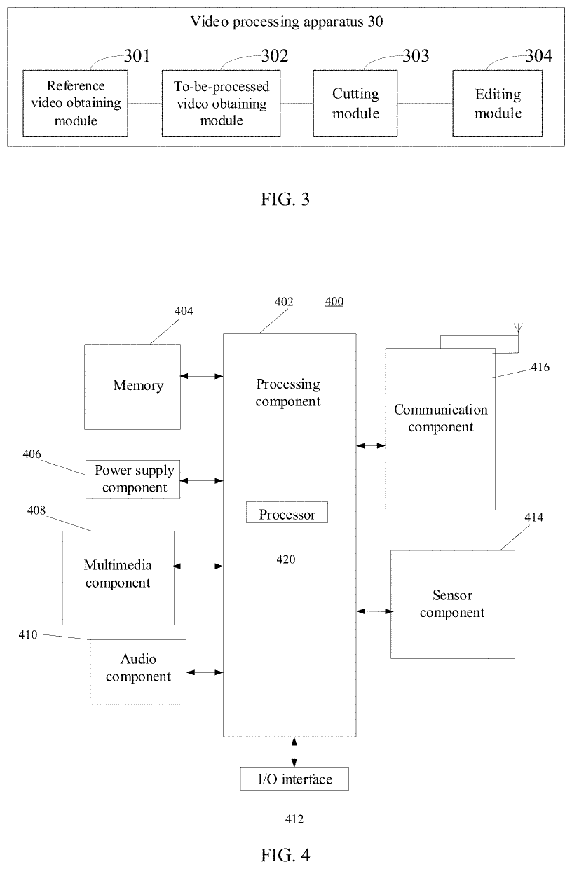

FIG. 3 is a block diagram of a video processing apparatus according to an example of the present disclosure. As shown in FIG. 3, the apparatus 30 may include: a reference video obtaining module 301, configured to obtain a reference video, where the reference video includes at least one type of processing parameters; a to-be-processed video obtaining module 302, configured to obtain a to-be-processed video; a cutting module 303, configured to obtain a plurality of frame sequences of the to-be-processed video by cutting the to-be-processed video; and an editing module 304, configured to obtain a target video by editing the plurality of frame sequences according to the at least one type of processing parameters of the reference video.

In one possible implementation, the target video is matched in mode with the reference video.

In one possible implementation, the target video being matched in mode with the reference video includes at least one of the following: background music of the target video is matched with background music of the reference video; and an attribute of the target video is matched with an attribute of the reference video.

In one possible implementation, the attribute of the target video being matched with the attribute of the reference video includes at least one of the following: a number of transitions included in the target video and a number of transitions included in the reference video belong to a same category, and/or occurrence time of a transition included in the target video and occurrence time of a transition included in the reference video belong to a same time range; a number of scenes included in the target video and a number of scenes included in the reference video belong to a same category, and/or, contents of a scene included in the target video and contents of a scene included in the reference video belong to a same category; a number of characters included in a segment of the target video and a number of characters included in a corresponding segment of the reference video belong to a same category; an editing style of the target video and an editing style of the reference video belong to a same type.

In one possible implementation, the editing module is configured to: obtain a plurality of first intermediate videos by performing several combinations for at least part of a plurality of frame sequences according to at least one type of processing parameters of the reference video, where each combination generates one first intermediate video; determine at least one of the plurality of first intermediate videos as a target video.

In one possible implementation, the editing module is further configured to: obtain a quality parameter of each of the plurality of first intermediate videos; determining a target video from the plurality of first intermediate videos according to each quality parameter, where a value of the quality parameter of the first intermediate video determined as the target video is greater than a value of the quality parameter of the first intermediate video not determined as the target video.

In one possible implementation, the video processing apparatus further includes: a target time range obtaining module, configured to obtain a target time range, where the target time range is matched with a time length of the target video. The editing module is further configured to obtain a plurality of first intermediate videos by performing several combinations for at least part of a plurality of frame sequences according to at least one type of processing parameters of the reference video and the target time range, where a time length of each of the plurality of first intermediate videos belongs to the target time range.

In one possible implementation, the processing parameters include a first processing parameter and a second processing parameter; the editing module is configured to obtain second intermediate videos by performing combination for at least part of frame sequences according to the first processing parameter; and obtain the target video by adjusting the second intermediate videos according to the second processing parameters.

In one possible implementation, the first processing parameter includes a parameter for reflecting basic data of the reference video; and/or, the second processing parameter includes at least one of: a parameter for indicating adding additional data to the second intermediate video, and a parameter for indicating cutting the second intermediate video.

In one possible implementation, the editing module is further configured to: in a case that the second processing parameter includes the parameter for indicating adding additional data to the second intermediate video, add the additional data to the second intermediate video for synthesis; and/or, in a case that the second processing parameter includes the parameter for indicating cutting the second intermediate video, adjust the length of the second intermediate video according to the second processing parameter.

In one possible implementation, the processing parameter includes at least one of: a transition parameter, a scene parameter, a character parameter, an editing style parameter and an audio parameter.

An example of the present disclosure further provides a computer readable storage medium storing computer program instructions thereon, where the computer program instructions are executed by a processor to perform the above method. The computer readable storage medium may be a volatile computer readable storage medium or a non-volatile computer readable storage medium.

An example of the present disclosure further provides an electronic device, including a processor and a memory storing instructions executable by the processor, where the processor is configured to perform the above method.

In an actual application, the above memory may be a volatile memory such as a Random Access Memory (RAM); or a non-volatile memory such as a Read-Only Memory (ROM), a flash memory, a hard disk drive (HDD) or a solid-state drive (SSD); or a combination of the memories of the above types, which are used to provide instructions or data to the processor.

The above processor may be at least one of Application Specific Integrated Circuit (ASIC), Digital Signal Processor (DSP), Digital Signal Processing Device (DSPD), Programmable Logic Device (PLD), Field Programmable Gate Array (FPGA), central processing unit (CPU), controller, microcontroller, and microprocessor. It may be understood that for different devices, other electronic devices may be used for realizing the functions of the above processor, and will not be limited herein.

The electronic device may be provided as a terminal, a server or another type of device.

Based on the same technical idea as in the preceding examples, an example of the present disclosure further provides a computer program which is executed by a processor to perform the above method.

FIG. 4 is a block diagram of an electronic device 400 according to an example of the present disclosure. For example, the electronic device 400 may be a mobile phone, a computer, a digital broadcast terminal, a message transceiver, a game console, a tablet device, a medical device, a fitness device, a personal digital assistant, and the like.

As shown in FIG. 4, the electronic device 400 may include one or more of the following components: a processing component 402, a memory 404, a power supply component 406, a multimedia component 408, an audio component 410, an input/output (I/O) interface 412, a sensor component 414 and a communication component 416.

The processing component 402 generally controls overall operations of the electronic device 400, such as operations associated with display, phone calls, data communications, camera operations, and recording operations. The processing component 402 may include one or more processors 420 to execute instructions to complete all or part of the blocks of the above methods. In addition, the processing component 402 may include one or more modules which facilitate the interaction between the processing component 402 and other components. For example, the processing component 402 may include a multimedia module to facilitate the interaction between the multimedia component 408 and the processing component 402.

The memory 404 is configured to store various types of data to support the operation of the electronic device 400. Examples of such data include instructions for any application or method operated on the electronic device 400, contact data, phonebook data, messages, pictures, videos, and so on. The memory 404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 406 supplies power for different components of the electronic device 400. The power supply component 406 may include a power supply management system, one or more power supplies, and other components associated with generating, managing and distributing power for the electronic device 400.

The multimedia component 408 includes a screen that provides an output interface between the electronic device 400 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 408 includes a front camera and/or a rear camera. When the electronic device 400 is in an operation mode, such as a shooting mode or a video mode, the front camera and/or the rear camera may receive external multimedia data. Each of the front and rear cameras may be a fixed optical lens system or have a focal length and an optical zoom capability.

The audio component 410 is configured to output and/or input audio signals. For example, the audio component 410 includes a microphone (MIC) configured to receive an external audio signal when the electronic device 400 is in an operation mode, such as a call mode, a recording mode, and a voice recognition mode. The received audio signal may be further stored in the memory 404 or transmitted via the communication component 416. In some examples, the audio component 410 also includes a loudspeaker for outputting an audio signal.

The I/O interface 412 provides an interface between the processing component 402 and a peripheral interface module which may be a keyboard, a click wheel, a button, or the like. These buttons may include, but are not limited to a home button, a volume button, a start button, and a lock button.

The sensor component 414 includes one or more sensors for providing a status assessment in various aspects to the electronic device 400. For example, the sensor component 414 may detect an open/closed state of the electronic device 400, and the relative positioning of components, for example, the component is a display and a keypad of the electronic device 400. The sensor component 414 may also detect a change in position of the electronic device 400 or a component of the electronic device 400, the presence or absence of a user in contact with the electronic device 400, the orientation or acceleration/deceleration of the electronic device 400 and a change in temperature of the electronic device 400. The sensor component 414 may include a proximity sensor configured to detect the presence of nearby objects without any physical contact. The sensor component 414 may also include a light sensor, such as a CMOS or CCD image sensor, for use in imaging applications. In some examples, the sensor component 414 may also include an acceleration sensor, a gyro sensor, a magnetic sensor, a pressure sensor, or a temperature sensor.

The communication component 416 is configured to facilitate wired or wireless communication between the electronic device 400 and other devices. The electronic device 400 may access a wireless network based on a communication standard, such as WiFi, 2G, 3G, 4G, 5G, or a combination thereof. In an example, the communication component 416 receives broadcast signals or broadcast associated information from an external broadcast management system via a broadcast channel. In an example, the communication component 416 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the electronic device 400 may be implemented by one or more application specific integrated circuits (ASICs), digital signal processors (DSPs), digital signal processing devices (DSPDs), programmable logic devices (PLDs), a field programmable gate array (FPGA), a controller, a microcontroller, a microprocessor or other electronic elements for performing the above methods.

In an example, there is also provided a non-volatile computer readable storage medium, such as a memory 404 including computer program instructions, where the instructions are executable by the processor 420 of the electronic device 400 to perform the method as described above.

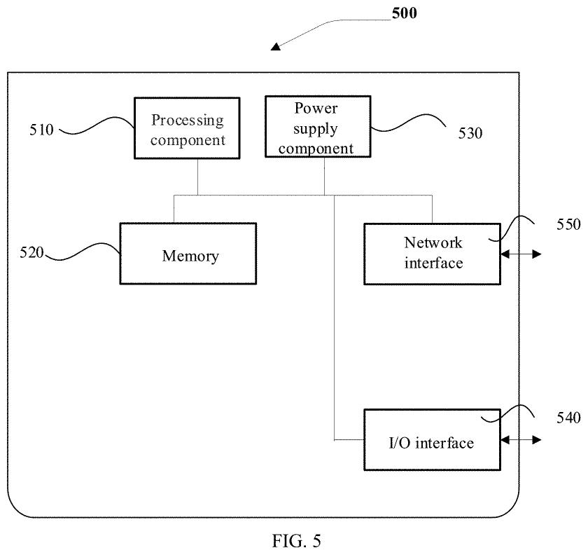

FIG. 5 is a block diagram of an electronic device 500 according to an example of the present disclosure. For example, the electronic device 500 may be provided as a server. As shown in FIG. 5, the electronic device 500 may include a processing component 510 which further includes one or more processors and memory resources represented by memory 520 for storing instructions executable by the processing component 510, for example, an application program. The application program stored in the memory 520 may include one or more modules, each of which corresponds to one set of instructions. Further, the processing component 510 is configured to execute instructions to perform the above method.

The electronic device 500 further includes one power supply component 530 configured to execute power management for the electronic device 500, one wired or wireless network interface 550 configured to connect the electronic device 500 to a network, and one input/output (I/O) interface 540. The electronic device 500 may be operated based on an operating system stored in the memory 520, such as Windows Server™, Mac OS X™, Unix™, Linux™ and FreeBSD™.

In an example, there is further provided a non-volatile computer readable storage medium, for example, the memory 520 including computer program instructions. The above computer program instructions may be executed by the processing component 510 of the electronic device 500 to perform the above method.

The present disclosure may be a system, a method and/or a computer program product. The computer program product may include a computer readable storage medium storing computer readable program instructions executable by the processor to perform various aspects of the present disclosure.

The computer readable storage medium may be a tangible device holding and storing instructions used by an instruction executing device. The computer readable storage medium may be, for example, but not limited to, an electric storage device, a magnetic storage device, an optical storage device, an electromagnetic storage device, a semi-conductor storage device, or any combination thereof. More specific examples (non-exhaustive list) of the computer readable storage medium include a portable computer disk, a hard disk, a Random Access Memory (RAM), a Read Only Memory (ROM), an Erasable Programmable Read-Only Memory (EPROM), a Static Random Access Memory (SRAM), a portable compact disk- read-only memory (CD-ROM), a digital versatile disk (DVD), a memory stick, a floppy disk, a mechanical encoding device (for example, a punched card storing instructions, or a groove convex structure), or any proper combination thereof. The computer readable storage medium used herein is not interpreted as instantaneous signal itself such as radio wave or other freely-propagating electromagnetic wave, electromagnetic wave propagating through waveguide or other transmission mediums (for example, optical pulse through optical fiber cable), or electrical signal transmitted through power line.

The computer readable program instructions described herein may be downloaded to various computing/processing devices from the computer readable storage medium or downloaded to an external computer or external storage device through a network such as internet, local area network, wide area network and/or wireless network. The network may include copper transmission cable, optical fiber transmission, wireless transmission, router, firewall, switch, gateway computer and/or edge server. A network adapter card or a network interface in each computing/processing device receives computer readable program instructions from the network and forwards the computer readable program instructions for storage in the computer readable storage mediums of various computing/processing devices.

The computer program instructions for executing the operations of the present disclosure may be assembly instruction, instruction set architecture (ISA) instruction, machine instruction, machine-related instruction, microcode, firmware instruction, state setting data, or source code or target code written in any combination of one or more programming languages. The programming language includes an object-oriented programming language such as Smalltalk and C++, and a regular procedural programming language such as C language or similar programming language. The computer readable program instructions may be entirely executed on a user computer, executed partially on a user computer, executed as an independent software package, executed partially on a user computer and partially on a remote computer, or executed entirely on a remote computer or server. In a case of a remote computer involved, the remote computer may be connected to the user computer through any type of network including a local area network (LAN) or a wide area network (WAN), or connected to an external computer, for example, through an internet provided by an internet service provider. In some examples, state information of the computer readable program instructions may be used to customize an electronic circuit such as a programmable logic circuit, a field programmable gate array (FPGA), or a programmable logic array (PLA), which can execute the computer readable program instructions to perform various aspects of the present disclosure.

Various aspects of the present disclosure are described by referring to the flowcharts and/or block diagrams of method, apparatus (system) and computer readable program products according to the examples of the present disclosure. It should be understood that each block of the flowcharts and/or block diagrams and any combination of various blocks of the flowcharts and/or block diagrams may be implemented by the computer readable program instructions.

These computer program instructions may be provided to a general-purpose computer, a dedicated computer, or a processor of another programmable data processing device to generate a machine so that the instructions are executed by a computer or a processor of another programmable data processing device to generate an apparatus for implementing function/action designated in one or more blocks of the flowcharts and/or block diagrams. These computer readable program instructions may also be stored in the computer readable storage medium to enable computer, programmable data processing device and/or another device to operate in a specific manner. In this case, the computer readable storage medium storing instructions may include one product including instructions for implementing various aspects of function/action designated in one or more blocks of the flowcharts and/or block diagrams.

These computer readable program instructions may also be loaded onto a computer, another programmable data processing device, or other devices to enable the computer, another programmable data processing device, or other devices to perform a series of operation blocks so as to generate a implementation process of computer, so that the instructions executable on the computer, another programmable data processing device, or other devices realize function/action designated in one or more blocks of the flowcharts and/or block diagrams.

The flowcharts and block diagrams in the accompanying drawings show the possibly-implemented system architecture, function and operation of the system, method, and computer readable program products in several examples of the present disclosure. At this point, each block in the flowcharts and/or block diagrams may represent a part of one module, program segment or instruction, which includes one or more executable instructions for realizing the designated logic functions. In some alternative implementations, the functions indicated in the blocks may also occur in a sequence different from the sequence indicated in the accompanying drawings. For example, two consecutive blocks may actually be performed in parallel or sometime performed in a reverse sequence, which depends on the functions involved. It is also noted that each block or any combination of blocks of the flowcharts and/or block diagrams may be realized by a dedicated hardware-based system used for performing the designated functions or actions, or realized by a combination of a dedicated hardware and a computer instruction.

The examples of the present disclosure described as above are illustrative and non-exhaustive and are not limited to these examples disclosed herein. It is apparent that many changes and modifications may be made by those skilled in the art without departing from the scope and spirit of the examples of the present disclosure. The selection of terms used herein is intended to best explain the principle and the practical applications of different examples or technical improvements of technologies in market, or different examples helping other ordinary persons skilled in the art to understand the present disclosure.

1. A video processing method, comprising:
obtaining a reference video, wherein the reference video comprises at least one type of processing parameters;
obtaining a to-be-processed video;
cutting the to-be-processed video to obtain a plurality of frame sequences of the to-be-processed video; and
editing the plurality of frame sequences according to the at least one type of processing parameters of the reference video to obtain a target video.

2. The video processing method according to claim 1, wherein the target video is matched in mode with the reference video.

3. The video processing method according to claim 2, wherein the target video being matched in mode with the reference video comprises at least one of:
background music of the target video being matched with background music of the reference video, or
an attribute of the target video being matched with an attribute of the reference video.

4. The video processing method according to claim 3, wherein the attribute of the target video being matched with the attribute of the reference video comprises at least one of:
a number of transitions comprised in the target video and a number of transitions comprised in the reference video belonging to a same category,
occurrence time of a transition comprised in the target video and occurrence time of a transition comprised in the reference video belonging to a same time range,
a number of scenes comprised in the target video and a number of scenes comprised in the reference video belonging to a same category,
contents of a scene comprised in the target video and contents of a scene comprised in the reference video belonging to a same category,
a number of characters comprised in a segment of the target video and a number of characters comprised in a corresponding segment of the reference video belonging to a same category, or
an editing style of the target video and an editing style of the reference video belonging to a same type.

5. The video processing method according to claim 1, wherein editing the plurality of frame sequences according to the at least one type of processing parameters of the reference video to obtain the target video comprises:
performing each of a plurality of combinations for at least part of the plurality of frame sequences according to the at least one type of processing parameters of the reference video to generate a respective first intermediate video; and
determining at least one of the respective first intermediate videos of the plurality of combinations as the target video.

6. The video processing method according to claim 5, wherein determining the at least one of the respective first intermediate videos of the plurality of combinations as the target video comprises:
obtaining a corresponding quality parameter of each of the respective first intermediate videos; and
selecting a first intermediate video from the respective first intermediate videos according to the corresponding quality parameters as the target video, wherein a value of a corresponding quality parameter of the selected first intermediate video is greater than a value of a corresponding quality parameter of an unselected first intermediate video among the respective first intermediate videos.

7. The video processing method according to claim 5, wherein before editing the plurality of frame sequences according to the at least one type of processing parameters of the reference video to obtain the target video, the method further comprises: obtaining a target time range matching a time length of the target video, and
wherein performing each of a plurality of combinations for at least part of the plurality of frame sequences according to the at least one type of processing parameters of the reference video to generate a respective first intermediate video comprises:
performing each of the plurality of combinations for the at least part of the plurality of frame sequences according to the at least one type of processing parameters of the reference video and the target time range to generate the respective first intermediate video, wherein a time length of the respective first intermediate video is within the target time range.

8. The video processing method according to claim 1, wherein the processing parameters comprise a first type processing parameter and a second type processing parameter, and
wherein editing the plurality of frame sequences according to the at least one type of processing parameters of the reference video to obtain the target video comprises:
performing a combination for at least part of the plurality of frame sequences according to the first type processing parameter to obtain at least one second intermediate video, and
adjusting the at least one second intermediate video according to the second type processing parameter to obtain the target video.

9. The video processing method according to claim 8, wherein the processing parameters comprise at least one of:
a parameter for reflecting basic data of the reference video as the first type processing parameter, or
at least one of a parameter for indicating adding additional data to the second intermediate video or a parameter for indicating cutting the second intermediate video as the second type processing parameter.

10. The video processing method according to claim 8, wherein adjusting the at least one second intermediate video according to the second processing parameter comprises at least one of:
in response to determining that the second processing parameter comprises a parameter for indicating adding additional data to the second intermediate video, synthesizing the additional data and the second intermediate video, or
in response to determining that the second processing parameter comprises a parameter for indicating cutting the second intermediate video, adjusting a length of the second intermediate video according to the second processing parameter.

11. The video processing method according to claim 1, wherein the processing parameters comprise at least one of: a transition parameter, a scene parameter, a character parameter, an editing style parameter, or an audio parameter.

12. The video processing method according to claim 1, wherein, before editing the plurality of frame sequences according to the at least one type of processing parameters of the reference video to obtain the target video, the video processing method further comprises:
detecting and learning the at least one type of processing parameters of the reference video by analyzing the reference video through a pre-trained neural network.

13. An electronic device, comprising:
at least one processor; and
one or more memories coupled to the at least one processor and storing programming instructions for execution by the at least one processor to perform operations comprising:
obtaining a reference video, wherein the reference video comprises at least one type of processing parameters;
obtaining a to-be-processed video;
cutting the to-be-processed video to obtain a plurality of frame sequences of the to-be-processed video; and
editing the plurality of frame sequences according to the at least one type of processing parameters of the reference video to obtain a target video.

14. The electronic device according to claim 13, wherein the target video is matched in mode with the reference video.

15. The electronic device according to claim 14, wherein the target video being matched in mode with the reference video comprises at least one of:
background music of the target video being matched with background music of the reference video; or
an attribute of the target video being matched with an attribute of the reference video, and
wherein the attribute of the target video being matched with the attribute of the reference video comprises at least one of:
a number of transitions comprised in the target video and a number of transitions comprised in the reference video belonging to a same category,
an occurrence time of a transition comprised in the target video and occurrence time of a transition comprised in the reference video belonging to a same time range;
a number of scenes comprised in the target video and a number of scenes comprised in the reference video belonging to a same category,
contents of a scene comprised in the target video and contents of a scene comprised in the reference video belonging to a same category;
a number of characters comprised in a segment of the target video and a number of characters comprised in a corresponding segment of the reference video belonging to a same category; or
an editing style of the target video and an editing style of the reference video belonging to a same type.

16. The electronic device according to claim 13, wherein editing the plurality of frame sequences according to the at least one type of processing parameters of the reference video to obtain the target video comprises:
performing each of a plurality of combinations for at least part of the plurality of frame sequences according to the at least one type of processing parameters of the reference video to generate a respective first intermediate video; and
determining at least one of the respective first intermediate videos of the plurality of combinations as the target video.

17. The electronic device according to claim 16, wherein determining the at least one of the respective first intermediate videos of the plurality of combinations as the target video comprises:
obtaining a corresponding quality parameter of each of the respective first intermediate videos; and
selecting a first intermediate video from the respective first intermediate videos according to the corresponding quality parameters as to be the target video, wherein a value of a corresponding quality parameter of the selected first intermediate video is greater than a value of a corresponding quality parameter of an unselected first intermediate video among the respective first intermediate videos.

18. The electronic device according to claim 16, wherein, before editing the plurality of frame sequences according to the at least one type of processing parameters of the reference video to obtain the target video, the operations further comprise: obtaining a target time range matching a time length of the target video, and
wherein performing each of a plurality of combinations for at least part of the plurality of frame sequences according to the at least one type of processing parameters of the reference video to generate a respective first intermediate video comprises:
performing each of the plurality of combinations for the at least part of the plurality of frame sequences according to the at least one type of processing parameters of the reference video and the target time range to generate the respective first intermediate video, wherein a time length of the respective first intermediate video is within the target time range.

19. The electronic device according to claim 13, wherein the processing parameters comprise a first type processing parameter and a second type processing parameter, and
wherein editing the plurality of frame sequences according to the at least one type of processing parameters of the reference video to obtain the target video comprises:
performing a combination for at least part of the plurality of frame sequences according to the first type processing parameter to obtain at least one second intermediate video, and
adjusting the at least one second intermediate video according to the second type processing parameter to obtain the target video.

20. A non-transitory computer readable storage medium coupled to at least one processor having machine-executable instructions stored thereon that, when executed by the at least one processor, cause the at least one processor to perform operations comprising:
obtaining a reference video, wherein the reference video comprises at least one type of processing parameters;
obtaining a to-be-processed video;
cutting the to-be-processed video to obtain a plurality of frame sequences of the to-be-processed video; and
editing the plurality of frame sequences according to the at least one type of processing parameters of the reference video to obtain a target video.
